(19) United States
(12) Patent Application Publication
(10) Pub. No.: US 2006/0200577 A1
(43) Pub. Date: Sep. 7, 2006

(54) Method for transmitting moving picture data to mobile terminal using pseudo-streaming technology

(75) Inventor: Seong-Jun Park, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/364,535

(22) Filed: Mar. 1, 2006

(30) Foreign Application Priority Data
Mar. 3, 2005 (KR) 17819/2005

(51) Int. Cl. G06F 15/16

(52) U.S. Cl. 709/231

(57) ABSTRACT

Disclosed is the transmission of moving picture data in a mobile terminal, and more particularly, a method for transmitting moving picture data in a mobile terminal using a pseudo-streaming technology, for more safely and reliably transmitting moving picture data packets by defining a new TCP-based Real-Time Pseudo-Streaming Protocol in order to transmit moving picture contents on the basis of the Transmission Control Protocol and using a pseudo-streaming technology. A bit stream of the Real-time Pseudo-streaming Protocol is made up of a total five of fields: ‘PS’ field, ‘Delimiter’ field, ‘Packet Size’ field, ‘Sequence Number’ field and ‘Data’ field.

### BACKGROUND OF THE INVENTION

1. Field of the Invention

The present invention relates to a method for transmitting moving picture data to a mobile terminal, and more particularly, to a method for transmitting moving picture data (i.e. video data) to a mobile terminal using a pseudo-streaming technology.

2. Description of the Background Art

A mobile communication system using a mobile communications terminal (hereinafter, referred to simply as a “mobile terminal”) provides moving picture multimedia services such as a Video On Demand (VOD) service as well as an audio signal or a text signal. In particular, the introduction of streaming technology allows the moving picture service to make rapid progress.

A streaming service is a multimedia service in which a user does not store all received multimedia data in a storage unit of a user's mobile terminal but receives and plays a multimedia content, and then discards the received data. Such a service is widely being used in wired communication but has received more attention in respect of a wireless mobile terminal typically having a limited storage space.

The technology for implementing the moving picture streaming is typically classified into an image compression algorithm, an audio compression algorithm and a wired and wireless network protocol.

Among them, the image compression algorithm is moving picture data format which is currently being used wiredly and wirelessly by using an image compression technique, and includes standardized ‘MPEG’-based formats such as MPEG-1 (Moving Picture Experts Group 1), MPEG-2 and MPEG-4 as designated by the International Standards Organisation (ISO) and the International Electrotechnical Commission (IEC), and ‘H.26x’ such as H.261, H.263 and H.264 designated by the ITU Telecommunication Standardization Sector (ITU-T). In particular, MPEG4 or H.263 have been established as international standards in a wireless environment such as for mobile telephone. The 3GPP (3rd Generation Partnership Project), an international mobile communication standard organization, and the 3GPP2 standard committee have adopted MPEG4 as a standard for VOD and H.263 as a standard for Video telephony (VT). In addition, with the development of compression technology and technology for the improvement of image quality, the demand for H.264 has caught up with the demands for MPEG-4 and H.263.

As for the audio compression algorithm, a wired and wireless audio algorithm such as MIDI (Musical Instrument Digital Interface), MP3 (Moving Picture Experts Group 3) and AAC (Advanced Audio Code), and QCELP (Qualcomm Code Excited Linear Prediction), EVRC (Enhanced Variable Coder), and AMR (Analog Microwave Radio) which are appropriate for the wireless environment are mainly being used. With the development of compression technology and technology for improvement of image quality, the demand for AAC+ is gradually increasing.

Wired and wireless network protocols include TCP (Transmission Control Protocol) which generally has a relatively low transmission speed but a high transmission reliability and UDP (User Datagram Protocol) which has a relatively high transmission speed but low transmission reliability. In the case of UDP, RTP (Real Time Protocol) and RTCP (Real Time Control Protocol) are additionally used to compensate for slight packet loss in most cases. RTSP (Real Time Streaming Protocol) and SDP (Streaming Datagram Protocol) are also used frequently as protocols used during the session in order to adaptively respond to such real-time service.

FIG. 1 is a diagram illustrating a VOD service method in a mobile terminal in accordance with the related art. The VOD service in the related art mobile terminal basically refers to an RTP-based streaming service using MPEG4 and MC codecs.

With reference to FIG. 1, when the mobile terminal user requests for transmission of contents by a TCP-based RTSP DESCRIBE method, in response to such request a streaming server retrieves appropriate contents from its own associated contents server and transmits to the user, a response describing basic information on the contents requested by the user. The information on the contents includes screen size, frame rate, codec type, present time, and the like. Next, after recognizing the contents information transmitted by the server, the user's mobile terminal transmits a SETUP method and starts playing a streaming of the requested contents. From this time, a TCP port connection between the server and the mobile terminal is disconnected. When moving picture data packet is transmitted to the mobile terminal by an RTP method or an RTCP method based on UDP, the mobile terminal displays the transmitted moving picture data packet on a screen of the mobile terminal and then discards the received data.

Since the UDP-based technology for providing a streaming service in the related art has a high transmission speed but cannot guarantee reliability of data, packet loss may occur during the streaming service. In addition, in the UDP-based streaming service in the related art, since the mobile terminal plays contents transmitted from the server and then should discard the played content immediately, the mobile terminal must re-connect to the server if the user wants to view the contents again. Accordingly, the user must pay additional costs for packet transmission.

### SUMMARY OF THE INVENTION

One aspect of the present invention involves the recognition by the present inventors of the drawbacks in the related art, as explained above. Based upon such recognition, improvements in transmitting moving picture data to mobile terminals providing moving picture multimedia services can be achieved according to the present invention.

Certain features that may be part of the moving picture data transmitting method and system will not be described in much detail, merely to prevent the characteristics of the present invention from being obscured. However, such additional features may also be part of the moving picture data transmitting system and method of the present invention, as would be understood by those skilled in the art.

Therefore, it is an object of the present invention to provide moving picture data to a mobile terminal by a Transmission Control Protocol method under stable streaming network environments.

It is another object of the present invention to provide moving picture data to a mobile terminal by using a pseudo-streaming method capable of playing a streaming video and also of downloading the same.

To achieve these and other advantages and in accordance with the purpose of the present invention, as embodied and broadly described herein, there is provided a method for transmitting (sending or delivering) moving picture data to a mobile terminal using pseudo-streaming in moving picture streaming transmission between a server and a mobile terminal, the method comprising: a step in which at least one field is added to Real Time Streaming Protocol in order that moving picture data service can be provided between the server and the mobile terminal by a protocol using a pseudo-streaming technology.

Preferably, the protocol is based on the Transmission Control Protocol, is capable of implementing real time pseudo-streaming, and is defined as the Real-time Pseudo-streaming Protocol.

Preferably, the field comprises a field indicating that the mobile terminal requests the server to transmit contents by pseudo-streaming and a further field indicating a size of one packet which can be received in the mobile terminal.

In addition, to achieve these and other advantages and in accordance with the purpose of the present invention, as embodied and broadly described herein, a method for transmitting moving picture data in a mobile terminal using pseudo-streaming implements pseudo-streaming by a bit stream of the Real-time Pseudo-streaming Protocol in moving picture streaming transmission between the server and the mobile terminal.

Preferably, the bit stream comprises a field of a pseudo-streaming start code, a field indicating a status of a Real-time Pseudo-streaming Protocol packet currently being received, a field indicating the Packet Size, a field indicating a Sequence Number of the data packet, and a Data field having actual data.

To achieve these and other advantages and in accordance with the purpose of the present invention, as embodied and broadly described herein, there is provided a method for transmitting moving picture data to a mobile terminal using pseudo-streaming in moving picture streaming transmission between a server and a mobile terminal, the method comprising: a step in which a user operates a Video on Demand player in the mobile terminal and a Transmission Control Protocol session is established between the mobile terminal and the server; a step in which the mobile terminal makes a Describe request to the server, and the server retrieves contents and prepares for service; a step in which the server makes a Describe response to the mobile terminal, and the mobile terminal sets an initial value of the Video on Demand player and prepares for pseudo-streaming service start; a step in which the server transmits the contents requested to be played as Real-time Pseudo-streaming Protocol packet data to the mobile terminal if the mobile terminal requests the server to play the specific contents; a step in which if the mobile terminal makes a TearDown request, the server responds to the TearDown request and terminates the transmission of the Real-time Pseudo-streaming Protocol packet data; and a step in which the mobile terminal closes the Video on Demand player and the Transmission Control Protocol session between the mobile terminal and the server is completed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a diagram illustrating a VOD service method of a mobile terminal in a related art;

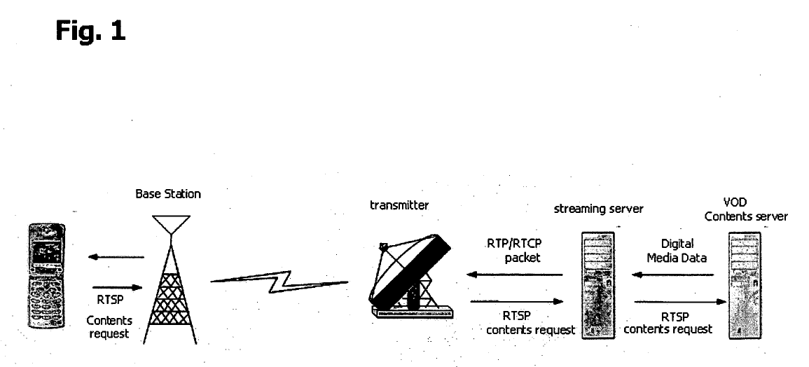

FIG. 2 is a diagram illustrating a process of performing moving picture data service between a mobile terminal and a server by using a TCP-based RPSP method in accordance with the present invention;

FIG. 3 is a flowchart of the process illustrated in FIG. 2; and

FIG. 4 illustrates a bit stream defining the TCP-based RPSP in accordance with the present invention.

### DETAILED DESCRIPTION OF THE PREFERRED EMBODIMENTS

Reference will now be made in detail to the preferred embodiments of the present invention, examples of which are illustrated in the accompanying drawings.

The present invention is implemented in a communications system providing moving picture data streaming service and a mobile terminal for using moving picture data streaming service. However, the present invention can be applied to a communications system and a terminal which operate according to other specifications.

Hereafter, the term “a mobile terminal” is intended to refer to and cover various types of communication devices that support mobility (or may be fixed) and allows communication of information via wired and/or wireless interfaces. Examples may include mobile stations, user equipment (UE), handsets, PDAs, etc.

The present invention is based on the premise that a mobile terminal has storage space capable of storing contents transmitted from a server in accordance with an expanded RAM area or with the development of a hard disc drive for a mobile terminal.

The present invention is to propose a method for more safely and reliably transmitting moving picture data packet by defining a new TCP-based RPSP in order to transmit moving picture contents on the basis of the TCP using a pseudo-streaming technology.

The present invention is devised in consideration of the fact that under communication environments guaranteeing network speed of a high-speed mobile communications network such as EVDO (Evolution Data Only), WCDMA (Wideband Code-Division Multiple Access) or the like, and limited storage space of the mobile terminal to a certain degree, a TCP-based pseudo-streaming service quality can provide better services to a user than a UDP-based streaming service in accordance with the related art.

Accordingly, in order to implement the TCP-based pseudo-streaming service, the RPSP (Real-time Pseudo-streaming Protocol) differentiated from the UDP-based RTP in the related art is defined. In addition, in order to perform moving picture service by RPSP based on TCP, new fields should be added to the RTSP, a TCP-based protocol necessary to provide the connection environment between the mobile terminal and the server. Table 1 illustrates the detailed field specification of the related art RTSP which has been revised by adding the new fields. That is, two new fields are added to the related art RTSP. The new fields are circled in the oval as shown in Table 1. First, the field ‘X-Pseudo-Streaming’ is added to indicate that the mobile terminal requests the server to transmit contents by pseudo-streaming. Second, the field ‘X-RPSP-Length’ indicates the size of one packet which the mobile terminal can receive from the server. The field for indicating the packet size is required because the TCP by nature receives the packet from the network by cutting off the packet by a unit of certain size.

TABLE 1

DESCRIBE rtsp://streaming.june.com:554/81100/00001/81100_00001.skm RTSP/1.0
CSeq: 1
Accept application/sdp
User-Agent

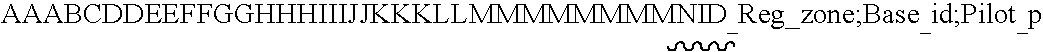

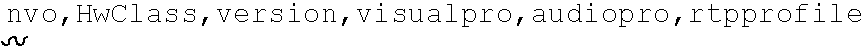

X-SKT-Client-Identity. [network-dependent-part]+ [network-independent-part]_{—[domain]}
X-SKT-Network-Info: OB, cCo=xxxx, cCa=xxxx, cNe=xxxx, oLo=abcebc...

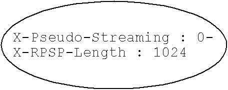

X-WAP-Profile: [URL]
X-WAP-Profile-Diff. // including all the HTTP header of Brawser
Accept-Language: in-KR

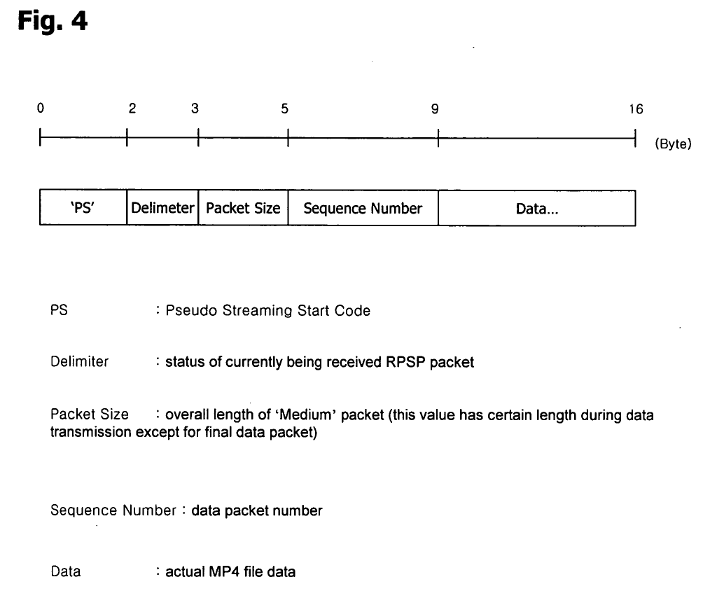

FIG. 4 illustrates a bit stream form defining the RPSP based on TCP.

As shown in FIG. 4, an RPSP bit stream is made up of a total of five fields: ‘PS’ field, ‘Delimiter’ field, ‘Packet Size’ field, ‘Sequence Number’ field and ‘Data’ field. First, the ‘PS’ field indicates a pseudo-streaming start code and comprises two bytes. The ‘Delimiter’ field indicates a status of an RPSP packet currently being received and transmitted between the mobile terminal and the server, and comprises one byte. The ‘Packet Size’ field indicates the overall length of the RPSP packet currently being transmitted, and comprises two bytes. The ‘Sequence Number’ field indicates the sequence number of the data packet, and comprises four bytes. Finally, the ‘Data’ field contains MP4 (Moving Picture Experts Group 4) file data, that is, moving picture data.

In particular, the ‘Packet Size’ field has a value of uniform length except for a final data packet while the moving picture data is transmitted from the server to the mobile terminal.

Table 2 illustrates the Delimiter existing in the RPSP. As shown in Table 2, the value in the ‘Delimiter’ field is expressed numerically. According to each number, the status of the RPSP packet currently being received and transmitted between the mobile terminal and the server is distinguished. There are four statuses of the RPSP packet on the basis of the ‘Delimiter’ field.

TABLE 2

| Number | Delimiter | Data flow | Description |
|---|---|---|---|
| 1 | Start | Server => Client | transmitting first data |
| 2 | Medium | Server => Client | transmitting data |
| 3 | End | Server => Client | transmitting final data |
| 4 | Read_Ok | Client => Server | reception OK |

First, when the value of the ‘Delimiter’ field is ‘1’, it indicates a ‘Start’ status in which the server transmits a first RPSP data packet to the mobile terminal. When the field value is ‘2‘, it indicates a ‘Medium’ status in which the server continues to transmit one or more RPSP data packets to the mobile terminal. When the field value is ‘3’;, it indicates an ‘End’ status in which the server transmits a final RPSP data packet to the mobile terminal. In addition, when the field value is ‘4’, it indicates that the mobile terminal notifies the server that the reception of the RPSP data packets is completed.

By using the ‘Delimiter’ field and the ‘Sequence Number’ field of the RPSP bit stream, the mobile terminal can find out how much data out of the entire data has been received from the server and determine which action should be taken according to each status, for example, when the first data packet received or when the final data packet is received.

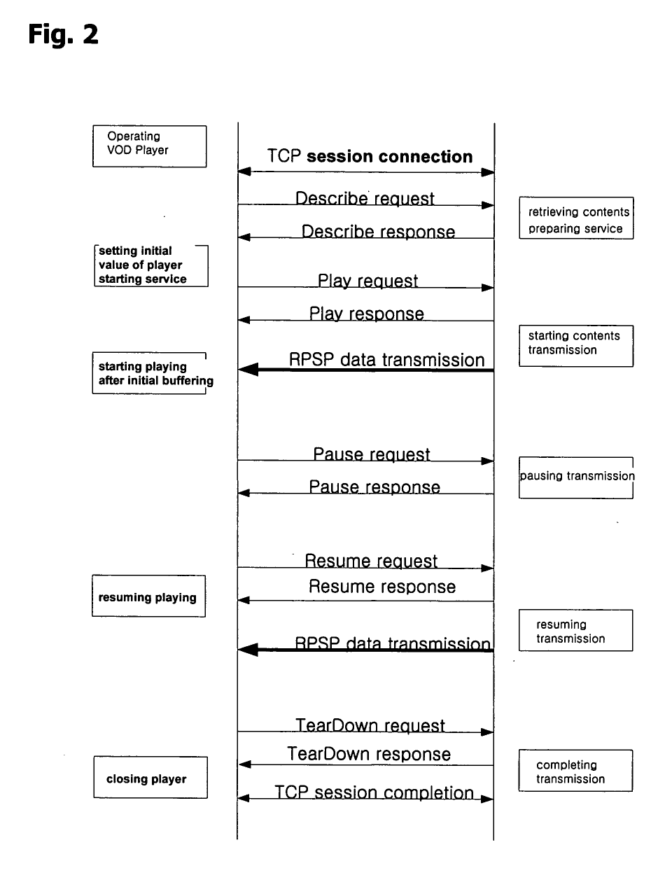

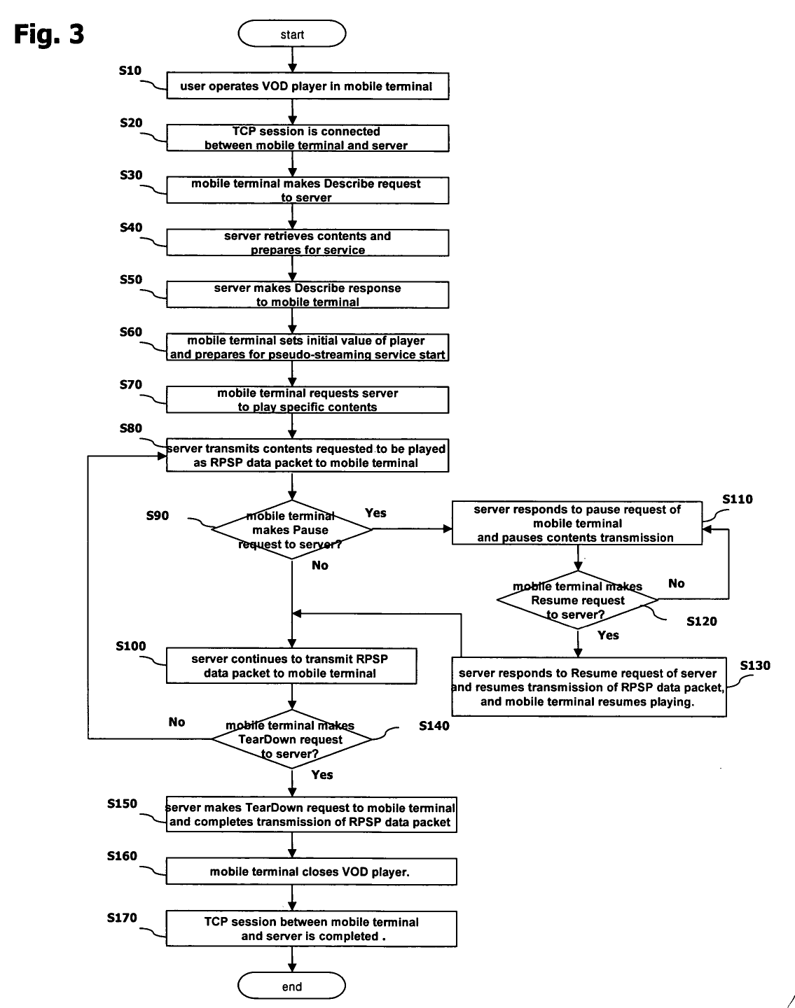

FIG. 2 illustrates a process of performing moving picture data service between a mobile terminal and a server by using the TCP-based RPSP method in accordance with the present invention. FIG. 3 is a flowchart of the process illustrated in FIG. 2.

With reference to FIGS. 2 and 3, the method for transmitting moving picture data using pseudo-streaming in accordance with the present invention will be described as follows.

When a user operates a VOD player in a mobile terminal (S10), a TCP session connection is made between the mobile terminal and a server (S20). In addition, when the user selects contents to receive moving picture data service and the user's mobile terminal sends a Describe request to the server (S30), the server retrieves the request contents and prepares for the service (S40). At this time, two fields are added to the RTSP based on TCP in the Describe requested from the mobile terminal to the server. That is, the field (X-Pseudo-Streaming) indicating that the mobile terminal requests the server to transmit the contents by pseudo-streaming and the field (X-RPSP-Length) indicating the packet size the mobile terminal can receive with respect to the packet transmitted from the server are included in the RTSP.

Subsequently, if the server responds to the Describe request of the mobile terminal (S50), the mobile terminal sets an initial value of the VOD player and prepares for pseudo-streaming service start by the TCP-based RPSP method provided from the server (S60). Then, if the mobile terminal requests the server to play the contents (S70), the server transmits the contents requested to be played as TCP-based RPSP data packets to the mobile terminal (S80). A bit stream structure of the RPSP data packets at this time is as shown FIG. 4.

If the mobile terminal requests ‘Pause’ from the server while the RPSP data packets are being transmitted in the step (S90), the transmission of further RPSP data is paused until the mobile terminal requests ‘Resume’ from the server (S110, S120 and S130). Then, when the mobile terminal makes a ‘TearDown’ request to the server (S140) and the server responds to the ‘TearDown’ request (S150), the VOD player of the mobile terminal is closed (S160) and the TCP session between the mobile terminal and the server is competed (S170).

As described so far, since the present invention transmits moving picture data using a pseudo-streaming technology based on TCP, a conversion from TCP into UDP is not required for the UDP-based moving picture streaming service in the related art. Accordingly, without the need for two IPs (Internet Providers) and two ports as required in the related art, the moving picture streaming service can be using only one IP and one port.

In addition, since the TCP-based streaming service is provided, more reliable data transmission is possible than in the related art UDP method. By preventing errors of network disconnection and packet loss which may occur during TCP/UDP conversion in the related art, the user can be provided with improved picture quality and audio quality.

Moreover, if the mobile terminal implementing the method in accordance with the present invention is provided with expanded RAM and a hard disc drive, a streaming of the VOD moving picture data is played while VOD moving picture data is being downloaded. Thus, the user does not need to pay additional transmission costs for playback.

The method for transmitting moving picture data in a mobile terminal using a TCP-based pseudo-streaming technology in accordance with the present invention can utilize both stability in downloading and rapid playback of the streaming service.

To implement the various features described above, the present invention can employ various types of hardware and/or software components (modules). For example, different hardware modules may contain various circuits and components necessary to perform the steps of the above method. Also, different software modules (executed by processors and/or other hardware) may contain various codes and protocols necessary to perform the steps of the present invention method.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method for sending moving picture data to a mobile terminal using a pseudo-streaming technology in moving picture streaming transmission between a server and a mobile terminal, the mobile terminal downloads moving picture data from the server and plays the moving picture data by using the pseudo-streaming technology based on the Transmission Control Protocol.

2. The method of claim 1, wherein the Transmission Control Protocol is implemented with applying Real-time Pseudo Streaming Protocol (RPSP) in order to perform the pseudo-streaming technology.

3. A method for transmitting moving picture data to a mobile terminal using pseudo-streaming technology in moving picture streaming transmission between a server and a mobile terminal, wherein one or more fields are added to a Real Time Streaming Protocol (RPSP) for invoking a moving picture data service between the server and the mobile terminal by a protocol using a pseudo-streaming technology.

4. The method of claim 3, wherein the protocol is defined on the basis of Transmission Control Protocol.

5. The method of claim 4, wherein the protocol is capable of implementing real time pseudo-streaming and is defined as the Real-time Pseudo-streaming Protocol.

6. The method of claim 3, wherein at least one of the fields comprises a request of mobile terminal for transmitting contents from the server by the pseudo-streaming technology.

7. The method of claim 3, wherein at least one of fields indicates a size of one packet that can be received in the mobile terminal.

8. A method for transmitting moving picture data to a mobile terminal using pseudo-streaming technology in moving picture streaming transmission between a server and a mobile terminal, wherein at least one of fields includes a bit stream of a Real-time Pseudo-Streaming Protocol that implemented in pseudo-streaming technology.

9. The method of claim 8, wherein the bit stream comprises:
a first field having a pseudo-streaming start code;
a second field indicating a status of a Real-time Pseudo-streaming Protocol packet currently being received;
a third field indicating the Packet Size;
a fourth field indicating a Sequence Number of the data packet; and
a fifth field containing actual moving picture data.

10. The method of claim 9, wherein the first field comprises two bytes.

11. The method of claim 9, wherein the second field comprises one byte.

12. The method of claim 9, wherein the third field comprises two bytes.

13. The method of claim 9, wherein the fourth field comprises four bytes.

14. The method of claim 9, wherein the Real-time Pseudo Streaming Protocol packet status represents a status of the Real-time Pseudo Streaming Protocol packet currently being transmitted and received between the server and the mobile terminal.

15. A method for transmitting a moving picture data to a mobile terminal using pseudo streaming in moving picture streaming transmission between a server and a mobile terminal, comprising:
a step in which a user operates a Video on Demand player in the mobile terminal and a Transmission Control Protocol session is established between the mobile terminal and the server;
a step in which the mobile terminal makes a Describe request to the server, and the server retrieves contents and prepares for service;
a step in which the server makes a Describe response to the mobile terminal, and the mobile terminal sets an initial value of the Video on Demand player and prepares for pseudo streaming service start;
a step in which the server transmits contents requested to be played as Real-time Pseudo Streaming Protocol packet data to the mobile terminal if the mobile terminal requests the server to play the specific contents;
a step in which if the mobile terminal makes a TearDown request, the server responds to the TearDown request and terminates the transmission of the Real-time Pseudo Streaming Protocol packet data; and
a step in which the mobile terminal closes the Video on Demand player and the Transmission Control Protocol session between the mobile terminal and the server is completed.

16. The method of claim 15, wherein the Real-time Pseudo Streaming Protocol is a protocol for transmitting a moving picture data packet by using the pseudo streaming based on Transmission Control Protocol.

17. The method of claim 15, wherein the Real-time Pseudo Streaming packet data comprises a field having a pseudo streaming start code, a field indicating a status of a Real-time Pseudo Streaming Protocol packet currently being received, a field indicating the Packet Size, a field indicating a Sequence Number of the data packet, and a Data field containing the actual moving picture data.

18. The method of claim 15, wherein the Real-time Pseudo Streaming Protocol packet status represents a status of a Real-time Pseudo Streaming Protocol packet currently being transmitted and received between the server and the mobile terminal.

19. The method of claim 15, wherein in the step in which the mobile terminal makes a Describe request to the server, one or more fields are added to a Real-time Streaming Protocol in order that moving picture data service can be provided by the Real-time Pseudo Streaming Protocol using pseudo streaming technology between the server and the mobile terminal.

20. The method of claim 19, wherein at least one of the fields comprises a request of mobile terminal for transmitting contents from the server by the pseudo-streaming technology.

21. The method of claim 19, wherein at least one of fields indicates a size of one packet that can be received in the mobile terminal.

22. A method for controlling video data in a wireless communication device providing a video multimedia service using a pseudo-streaming technology, the method comprising:
checking whether a Transmission Control Protocol session is established between the mobile terminal and a server;
sending a request message to retrieve a service content in the video multimedia service from the server;
setting an initial value of the video data upon receiving a response message with respect to the requested message;
receiving a Real-time Pseudo Streaming Protocol (RPSP) packet data; wherein the RPSP packet data comprises one or more fields having a bit stream of a Real-time Pseudo-Streaming Protocol that implemented in the pseudo-streaming technology.
displaying the service content in the wireless communication device with corresponding to the received RPSP packet data; and
transmitting a stop message to terminate the video multimedia service.
